(19) United States
(12) Patent Application Publication
(10) Pub. No.: US 2026/0261075 A1
(43) Pub. Date: Sep. 3, 2026

(54) CABLE AND CONNECTOR ASSEMBLY WITH AUXILIARY STRAIN RELIEF FEATURES

(71) Applicant: Amphenol Cable and Interconnect Technologies, Inc., St. Augustine, FL (US)

(72) Inventors: Joseph W. Chvala, St. Augustine, FL (US); Stephen Yawn, St. Augustine, FL (US)

(21) Appl. No.: 19/555,439

(22) Filed: Mar. 3, 2026

Related U.S. Application Data
(60) Provisional application No. 63/766,115, filed on Mar. 3, 2025.

(51) Int. Cl. H01R 13/58

(52) U.S. Cl. CPC H01R 13/5812

(57) ABSTRACT

A device for providing strain relief to a cable having a bend radius and terminated at a connector includes an auxiliary strain relieve element or portion having a body defining a passage therethrough for a cable to pass through the body. The body is formed of a rigid material and includes a longitudinal portion configured for interfacing with a connector and with the cable. The body further has a flared portion contiguous with the longitudinal portion for directing a cable and controlling flexure of the cable. The flared portion has a curved inner surface that presents an effective bend radius that is equal to or exceeds the bend radius of the cable.

### RELATED APPLICATIONS

The present application claims the priority of U.S. Provisional Application Serial No. 63/766,115 Filed Mar. 3, 2025. That application is incorporated by reference herein in its entirety.

### TECHNICAL FIELD OF INNOVATION

The present disclosure is directed to a strain relief in a cable and particularly to enhanced or auxiliary strain relief system for cable and connector assemblies that are used in a dynamic application with significant movement.

### BACKGROUND OF THE INNOVATION

Cables and cable assemblies of various constructions will often be susceptible to wear and damage at terminal ends thereof, such as at a juncture with a cable connector or connector assembly The terminal or connector juncture is where the cable is often anchored and so any stress or forces on the cable, such as pulling or bending of the cable, is usually translated to that connector juncture. Such forces, if strong enough, or repetitive enough, will cause damage to the cable at the connector juncture. For example, the outer insulation of a cable might be cracked or torn, thus exposing the inner conductor or fiber components to damage or contaminants. Furthermore, the conductors themselves may break or be damaged by motion and the forces of cable usage. In other scenarios, where pulling and strain forces are applied to the cable, the actual conductors may be pulled away from the connector assembly, thus jeopardizing the overall function of the cable.

Another issue presented at a connector juncture, particularly for cables used in dynamic settings wherein the cable, or a device connected to the cable, is moved or bent repeatedly and significantly in use, is the sharp angle presented to a cable in motion at the connector backplane. More specifically, certain connectors such as military specification or mil-spec connectors have bodies or back shells that create a sharp edge at the interface with a cable. As the end of the cable extending from such a connector is moved or bent at a right angle longitudinal axis of the connector, the cable may be forced against such a sharp edge causing damage to the layers or the cable or stress on the conductors themselves, causing damage and breakage.

Accordingly, in cable construction, protection and relief at the connector juncture, commonly referred to as strain relief, may be provided to mitigate some of the damage and address some of the forces at the connector juncture in normal cable usage and also in atypical usage. In one solution, strength members or metal braids are used and then anchored at the connector to combat pulling forces and other strain forces on the cable to prevent separation of the cable components from the connector. The back shell or other connector components capture the strength member or braid to provide an anchor of the cable to the connector. However, such a solution does not allow the strain to be distributed over a longer section of the cable. Nor does that solution address the sharp interface at the back shell or provide sufficient strain relief over a tight bend. In another solution, an arm extends rearwardly from the connector or back shell and clamps the cable rearwardly of the back shell. However, such a solution only adds additional strain relief in static applications and does not address repetitions and dynamic action of the cable.

In still other applications, a flexible polymer or heat-shrink material or boot might be implemented rearwardly of the cable and be form fitted to the cable. While such a design provides some strain relief in a static setting, it is not as useful for dynamic cable use. For example, in dynamic applications, such a design actually may add additional strain to the cable.

### SUMMARY OF DISCLOSED EMBODIMENTS OF THE INNOVATION

A disclosed embodiment presents a device for providing strain relief to a cable having a bend radius and terminated at a connector. The device includes an auxiliary strain relieve element that a body defining a passage therethrough for a cable to pass through the body. The body is formed of a rigid material and includes a longitudinal portion configured for interfacing with a connector and with the cable. The body further has a flared portion contiguous with the longitudinal portion for directing a cable and controlling flexure of the cable. The flared portion has a curved inner surface that presents an effective bend radius that is equal to or exceeds the bend radius of the cable. A cable interface element formed of a flexible material that is more flexible than the body of the auxiliary strain relieve element is configured to fit around the cable. The auxiliary strain relief element captures the cable interface element and cable. In one embodiment, a groove is formed around an inside surface and is configured to receive the cable interface element so the auxiliary strain relief element captures the cable interface element and cable. In another version, the body includes multiple sections in a clam-shell configuration for forming the passage therethrough The cable interface element may have multiple diameters for interfacing with a cable and connector.

Another disclosed embodiment presents a connector for providing strain relief to a cable having a bend radius. The connector includes a first connector element and a second connector element configured to interface with the first connector element. The second connector element includes a connector body defining a passage therethrough for a cable to pass through the body. The body is formed of a rigid material and includes a back shell portion configured for interfacing with the first connector element and an auxiliary strain relief portion. The auxiliary strain relief portion of the body has a flared portion extending integrally from the back shell portion for directing a cable and controlling flexure of the cable. The flared portion has a curved inner surface that presents an effective bend radius that is equal to or exceeds the bend radius of the cable. In one embodiment, the back shell portion may include threads for coupling with the first connector element. An anchor ring element is configured for anchoring a portion of a cable and for being captured between the back shell portion of the second connector element and first connector element.

Another disclosed embodiment presents a connector for providing strain relief to a cable having a bend radius and terminated at the connector. The connector includes a first connector element and a second connector element configured to interface with the first connector element. The second connector element includes a back shell portion formed of a rigid material and an auxiliary strain relief portion formed of a rigid material and having a body defining a passage therethrough for a cable to pass through the body. At least one leg, and possibly a plurality of legs, couples the auxiliary strain relieve portion with the back shell portion rearwardly of the back shell portion. The auxiliary strain relief portion body has a flared portion for directing a cable and controlling flexure of the cable. The flared portion has a curved inner surface that presents an effective bend radius to the cable that is equal to or exceeds the bend radius of the cable. A cable interface element formed of a flexible material that is more flexible than the body of the auxiliary strain relieve element is configured to fit around the cable. The auxiliary strain relief element captures the cable interface element and cable. In one embodiment, a groove is formed around an inside surface and is configured to receive the cable interface element so the auxiliary strain relief element captures the cable interface element and cable. In another version, the body includes multiple sections in a clam-shell configuration for forming the passage therethrough

### BRIEF DESCRIPTION OF THE DRAWING FIGURES

The accompanying drawings, which are incorporated in and constitute a part of this specification, illustrate embodiments of the disclosure and, together with a general description given below, serve to explain the principles of the embodiments.

FIG. 1 is a perspective exploded view of an embodiment of a cable and connector assembly with auxiliary strain relief features in accordance with features of the disclosed innovations.

FIG. 2 is a side view of an element of the cable and connector assembly with auxiliary strain relief features illustrated in FIG. 1.

FIG. 3 is a top view of an element of the cable and connector assembly with auxiliary strain relief features illustrated in FIG. 1.

FIG. 4 is a perspective view of an element of the cable and connector assembly with auxiliary strain relief features illustrated in FIG. 1.

FIG. 4A is a front view of an element of the cable and connector assembly with auxiliary strain relief features illustrated in FIG. 4.

FIG. 5 is a disassembled view, in cross section, of the embodiment of a cable and connector assembly with auxiliary strain relief features as disclosed herein.

FIG. 6 is a partially disassembled view, in cross section, of the embodiment of a cable and connector assembly with auxiliary strain relief features as illustrated in FIG. 5.

FIG. 7 is an assembled view, in cross section, of the embodiment of a cable and connector assembly with auxiliary strain relief features illustrated in FIG. 5.

FIG. 8 is a perspective view of an alternative embodiment of a cable and connector assembly with auxiliary strain relief features in accordance with features of the disclosed innovations.

FIG. 9 is a side view of an element of the cable and connector assembly with auxiliary strain relief features illustrated in FIG. 8.

FIG. 10 is a top view of an element of the cable and connector assembly with auxiliary strain relief features illustrated in FIG. 8.

FIG. 11 is an exploded view, in partial cross section, of elements of the cable and connector assembly with auxiliary strain relief features illustrated in FIG. 8.

FIG. 12 is a partially assembled view, in cross section, of the embodiment of a cable and connector assembly with auxiliary strain relief features illustrated in FIG. 8.

FIG. 13 is a further assembled view, in cross section, of the embodiment of a cable and connector assembly with auxiliary strain relief features illustrated in FIG. 8.

FIG. 14 is a perspective view of another alternative embodiment of a cable and connector assembly with auxiliary strain relief features in accordance with features of the disclosed innovations.

FIG. 15 is an assembled view, in cross section, of the embodiment of a cable and connector assembly with auxiliary strain relief features as illustrated in FIG. 14.

It should be understood that the appended drawings are not necessarily to scale, presenting a somewhat simplified representation of various features illustrative of the basic principles of the illustrated embodiments. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding.

### DETAILED DESCRIPTION OF DISCLOSED EMBODIMENTS OF THE INNOVATION

The disclosure and disclosed embodiments address the noted shortcomings and other deficiencies in the prior art of cable construction. The disclosure is illustrated by way of examples and not by way of limitation in the figures of the accompanying drawings in which like references indicate similar elements. It should be noted that reference to “an” or “one” embodiment in this disclosure are not necessarily to the same embodiment, and such references mean “at least one” of the embodiments.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

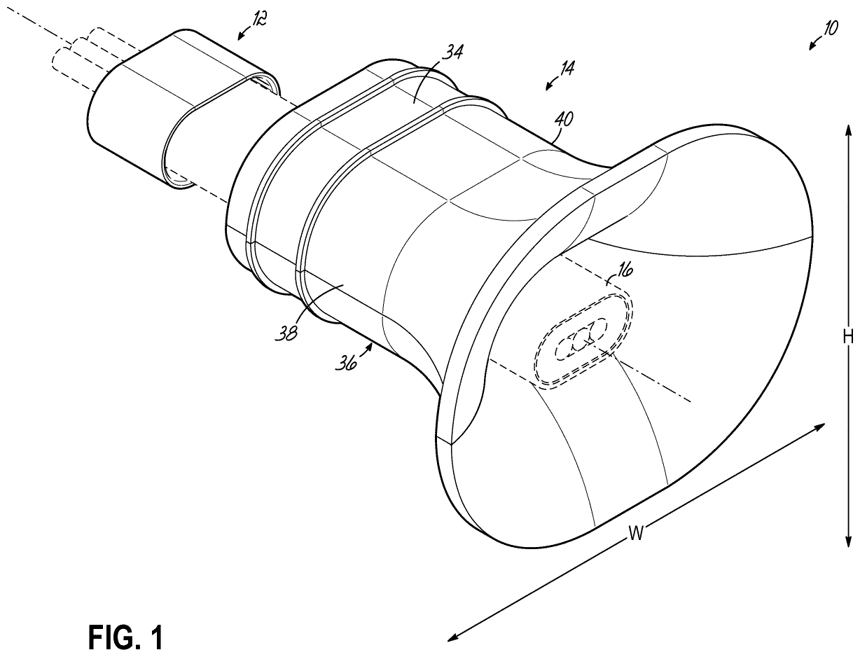

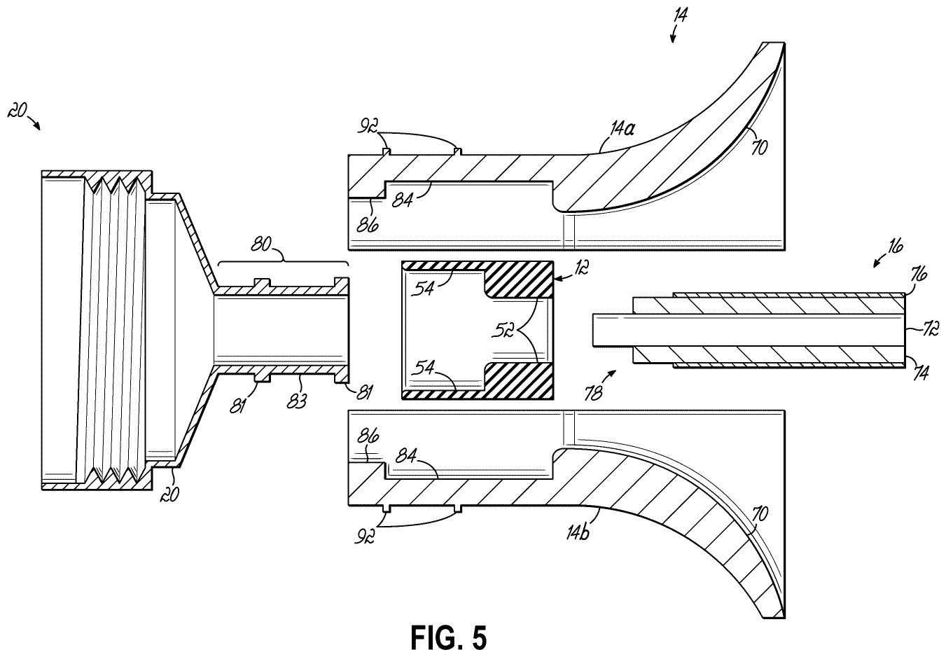

FIG. 1 is a perspective view of one embodiment of the innovation showing a cable and connector assembly with auxiliary strain relief features. Specifically, the auxiliary strain relief system disclosed herein is configured for interfacing with a connector assembly at a terminal or connector end of a cable. Together with the cable and connector, the disclosed embodiment creates a cable and connector assembly with desired auxiliary strain relief features. The auxiliary strain relief system 10 includes a cable interface element 12 and an auxiliary strain relief element 14 that interfaces with the cable interface element 12 at the end of a cable 16. The systems is configured proximate to a connector at the termination of the cable. Specifically, the terminal end of cable 16 will be terminated with a connector system and the auxiliary strain relief system 10 provides an appropriate strain relief function while preventing the terminal end from damage due to repeated bending and flexure. The auxiliary strain relief system of the disclosed innovation provides distribution of the cable strain in dynamic cable uses over a significant section of cable and increases the flex radii of cables subjected to significant dynamic flexing. The innovation also provides desired strain relief in static applications and uses. The auxiliary strain relief system 10 is implemented with a connector assembly or connector 20 that terminates the cable 10 (see FIG. 5) and provides protection at the cable at the cable/connector interface and rearwardly thereof.

One type of connector assembly for implementation or use with the disclosed innovation, as shown in the illustrated examples, is a circular military specification (mil-spec) connector that incorporates a back shell that is threaded onto or otherwise secured with another portion of a connector (back shell connector). Herein, with one disclosed embodiment, the connector assembly or connector 20 will be referred to as the back shell. However, the disclosed embodiments will have use with other connector assemblies and connector designs as well that might not include a back shell portion but still are dynamic and need an appropriate strain relief function while preventing the terminal end of a cable from damage due to repeated bending and flexure. Accordingly, the present disclosure is not limited to the illustrated examples of the connector 20 or the connector system back shell.

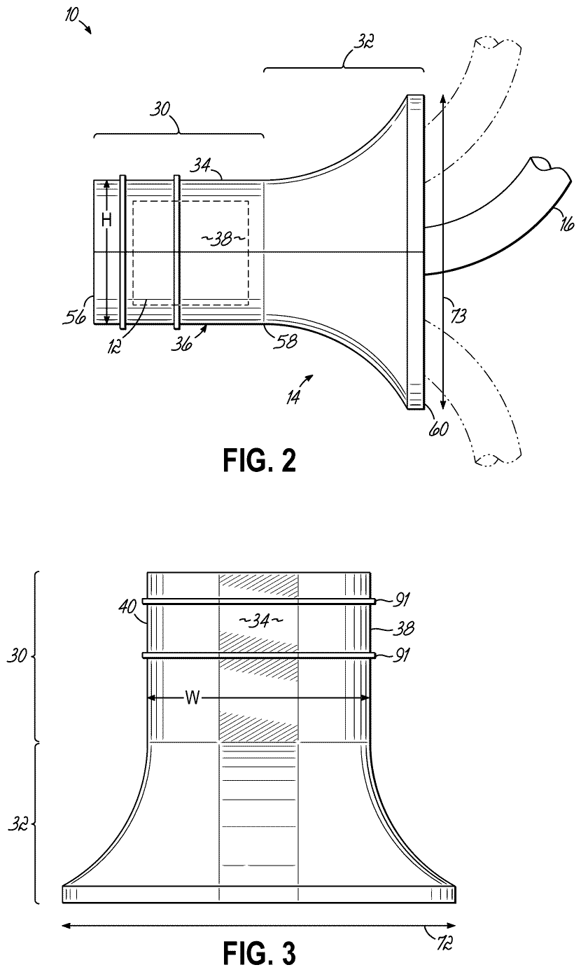

FIG. 2 is a side schematic view of an element 14 of the auxiliary strain relief system 10 of the disclosed embodiments, apart from the connector back shell 20 interface. FIG. 2 illustrates the horizontal restriction of the cable 16 and the vertical containment and limitation of the cable 16 during flexure to a more controlled radius of flexure, thus preventing damage to the cable during repeated dynamic use. Specifically, the auxiliary strain relief element 14 has a body that forms a passage therethrough. The passage is configured for a cable to pass through the body. The body includes a longitudinal portion 30 and a flared portion 32 contiguous with the longitudinal portion 30 and extending from an end of the longitudinal portion 30. The longitudinal portion 30 is configured for interfacing with the connector 20 and with a cable for securing the strain relief element 14 with the cable and connector assembly. The flared portion 32 controls the flexure of the cable passing through the body. The longitudinal and flared portions 30, 32 have a rounded or encircling cross-sectional shape for encircling the end of a cable 16 to allow flexure in various directions.

In the illustrated embodiment, the rounded cross-sectional shape is in the form of an oval as illustrated in FIG. 1, wherein the width W is greater than a height H. Depending on the cable, other rounded or encircling cross-sectional shapes, such as a circular cross-section, may be implemented. Similarly, depending on the shape of the cable and the application, the cable interface element 12 and the auxiliary strain relief element 14 may take other cross-sectional shapes, such as square or rectangular shapes, although the rounded/encircling shapes are more traditional cross-sections in cable and connector system designs.

Referring to FIGS. 2 and 3, the longitudinal portion 30 of the illustrated embodiment defines generally planar top and bottom surfaces, 34, 36 and rounded or curved side surfaces 38, 40. As discussed further herein, one embodiment of the auxiliary strain relief element 14 may incorporate a clam-shell design wherein upper and lower portions come together around the cable interface element 12 and the end of a cable 16 to form the auxiliary strain relief system 10.

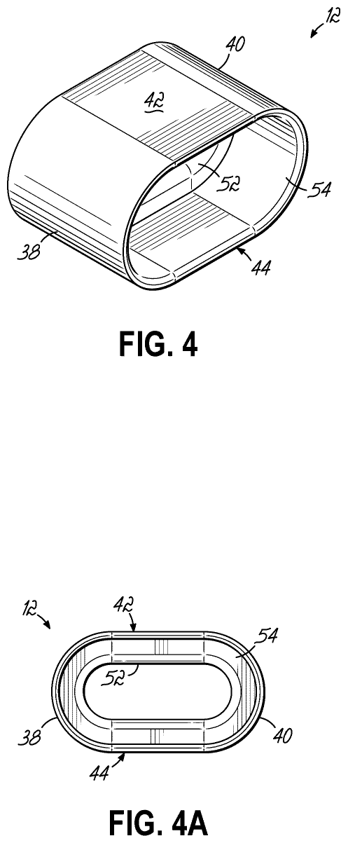

Referring to FIGS. 4 and 4A, the cable interface element 12 in the illustrated embodiment interfaces with the shield or strength member element of the cable and a portion of the back shell when the system 10 is assembled. The cable interface element 12 also has an oval cross-sectional shape and will generally match the cross-sectional shape of the auxiliary strain relief element 14, so it can have other cross sectional shapes. The cable interface element 12 of the illustrated embodiment also defines generally planar top and bottom surfaces, 42, 44 and rounded or curved side surfaces 38, 40 for a snug fit with the auxiliary strain relief element 14. In accordance with the disclosed embodiments, the cable interface element 12 captures a portion of the terminal end of the cable, as shown in FIGS. 5-7, and interfaces with a connector, such as the end of a back shell structure 20. The cable interface element 12 also couples with an inside cavity 50 of auxiliary strain relief element 14 for securing the auxiliary strain relief element 14 in the cable/connector assembly as discussed herein.

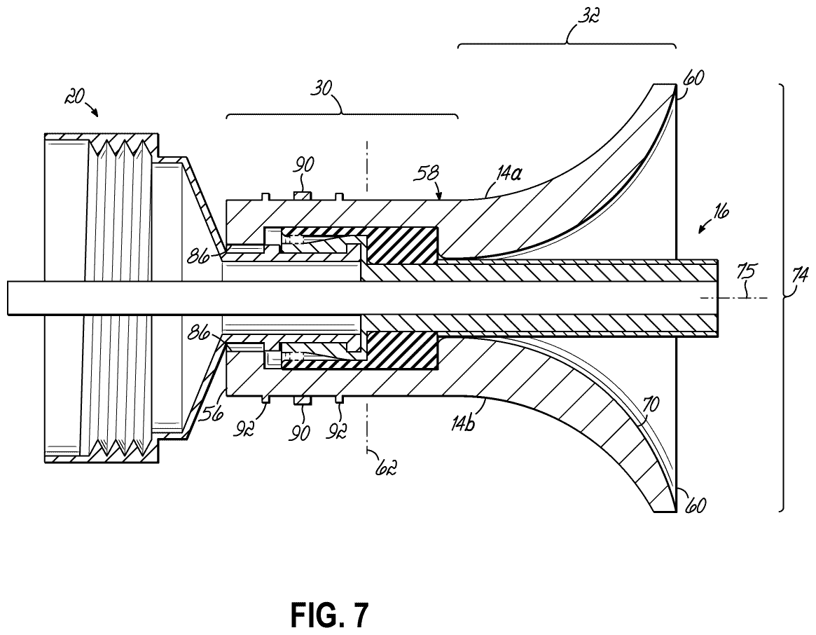

As shown in FIGS. 4 and 5, the cable interface element 12 has a first inner diameter 52 and a second and larger inner diameter 54. The first inner diameter 52 is tailored to provide a snug or tight interface with the outside surface of a cable 16 so that the cable is held securely in the element 14. The larger second inner diameter 54 provides additional space for an appropriate interface with the outside surface of the back shell, such as a rearward or nipple portion 21 of the back shell 20 and the thickness of a shield 74 of the cable 16 anchored to the back shell, as discussed herein and shown in FIG. 7. In that way, element 14 is tightly secured to the cable and back shell and the cable is somewhat immobilized at the back shell. Furthermore, the shield of the cable and whatever securement devices hold the shield to the back shell, such as bands, snaps or fasteners, are protected. The inner diameter dimensions for diameters 52 and 54 may be appropriately selected for the size of cable to be terminated as well as the back shell dimensions in accordance with the disclosed embodiments. The differential between the first inner diameter 52 and the larger second inner diameter 54 may be chosen to address the cable thickness or diameter differential from an outer diameter or outer dimension of the back shell portion 21 and the thickness of a shield element of the cable. To secure the cable interface element, it may be glued to the cable or may be overmolded. FIG. 5 shows element 12 in position in the assembly.

The material forming the cable interface element 12 is flexible and is made of a material that may be selected from an appropriate material to provide some flexibility for fitting over the back shell portion 21 and the thickness of a shield element 74 of the cable 16. For example, an epoxy material might be implemented and could be injected into the strain relief element 14. Alternatively, a polymeric material such as PTFE, silicon, or a fluoroelastomer like VITON might be used. It should be understood that the type of material utilized is not limiting to the disclosed embodiments. However, the material of the cable interface element 12 should be flexible and more flexible than the strain relief element 14 to be manipulated over the cable 16 and over the shield 74 and back shell portion 80. The auxiliary strain relief element 14 will generally be more rigid for providing rigid securement of the cable therein and distribution of the cable strain over a significant section of cable as well as confinement of the cable for increasing the flex radii of a cable subjected to significant dynamic flexing. The cable interface element 12 provides protection for the shield element of the cable as well at its interface with the connector back shell 20 and has the ability to change dimension with temperature to provide a robust interface between the cable 16 and the auxiliary strain relief element 14 during various operating conditions and temperatures.

The material forming the auxiliary strain relief element 14 may be selected from an appropriate rigid material to provide rigidity for containing the end of the cable proximate the connector and defining a particular bend radius. That is, the auxiliary strain relief element 14 has greater rigidity than the cable interface element 12. For example, one or more materials in the group of cast aluminum, stamped steel, PEEK polymers, or a thermoplastic such as TORLON PAI might be implemented for the more rigid auxiliary strain relief element 14.

In accordance with one feature of the disclosed embodiments, the auxiliary strain relief element 14 immobilizes the cable proximate to the back shell and termination end while simultaneously moving the flex point of the cable rearwardly from the back shell and also limiting the flexure or flex radius where the cable exits the auxiliary strain relief element 14. To that end, auxiliary strain relief element 14 has a longitudinal portion 30 (see FIG. 7) that has an effective length from an end 56 of the auxiliary strain relief element 14 to the interface 58 with the flared portion 32. That longitudinal spacing will vary with the size of the cable and may be in the range of ⅛th to 3 inches. The longitudinal portion 30 couples directly with the end of the back shell and thus increases the effective rearward length of the back shell in order to move the point of cable flexure further rearwardly from the connector. This prevents a sharp bend interface at the rear plane 62 of the connector back shell in order to prevent damage and maintain integrity at the anchor point of the shield 74 of the cable as illustrated in FIGS. 5-7.

The longitudinal portion 30 moves the point of flexure and the strain away from the back shell or other connector portion to the beginning of the flared portion 32 (see FIG. 7) so that the radius of flexure or bending may be more appropriately controlled to a defined radius as illustrated in FIG. 2. This effectively increases the bend radius with respect to the bend radius of the cable and prevents damage to the terminal end of the cable at the connector and connector back shell 20. The present innovation and the minimum radius that will be allowed thereby will vary and is reflective of the cable with which it is used.

The bend radius of a cable is generally measured to the inside curvature of the bent cable and reflects the minimum radius that you should bend the cable without kinking it, damaging it, or shortening its life. Generally the bend radius may be reflective of the diameter of the cable and can be 2× to 12× the outer diameter of the cable, for example. The smaller the bend radius, the greater the material flexibility because as the bend radius of curvature decreases, the curvature or bend of the cable increases. The flared portion 32 has a curved inner surface 70 that progresses from the interface point 58 out to the end 60 of the flared portion 32 (see FIG. 2). In accordance with one feature of the disclosed embodiments, the flared portion 32 and the curved inner surface 70 present an effective radius in the vertical plane of the cable that is equal to the bend radius of the cable. That is, the flared portion and inner surface effectively reflect the smallest bend radius for the particular cable. The flared portion surface 70 will ensure that the cable is contained as shown in FIG. 2 so as not to bend at a curvature that is greater than the curvature defined by the bend radius of the cable. Alternatively, the curved surface 70 may be configured to confine the flexing of the cable to a bend radius equal to or exceeding the bend radius of the cable, but the surface will ensure that the cable does not flex or bend to a bend radius below the rated minimal bend radius of the cable.

In the illustrated embodiment of the Figures, the open end of the flared portion 32 has a maximum vertical opening dimension 73 or height H that is smaller than a maximum horizontal dimension 72 or width W, presenting an oblong or oval opening at the end 60. (See FIG. 1) Of course, the auxiliary strain relief element 14 may have a circular cross-section also as noted.

FIGS. 5-7 illustrate an assembly of one embodiment 10 onto the terminal end of a cable 16 at the back shell 20. The relative sizes and dimensions of the element of embodiment 10 are not necessarily to scale and are shown for illustrative purposes primarily. A particular cable construction and a particular back shell design are illustrated for demonstrating the disclosed embodiments; however, it will be readily understood that the disclosed embodiments would be applicable to other back shell shapes and other cable designs beyond those shown, with only slight modifications or dimensional changes to the elements that would be understood by a person of ordinary skill in the art. Referring to FIG. 5, cable 16 is illustrated. The cable 16 may have many configurations with respect to its construction and components, such as the number of conductors, layers of insulation and materials utilized and so the present disclosed embodiments are not limited to a particular cable design. For illustration, a cable 16 has one or more conductors 72, with each conductor covered in an appropriate insulative layer 74, 76 for electrical isolation in the cable. An outer element, such as a shield or outer conductor 74, surrounds the one or more conductors 72. The element 74 might also be a strength member, such as a strength member containing Kevlar or another aramid material, but in the description herein, the element 74 is broadly referred to as a shield. The shield 74 may have a woven or braided construction, or may have another appropriate construction. A jacket 76 or other insulation layers might surround the various components 72,74 to complete the cable.

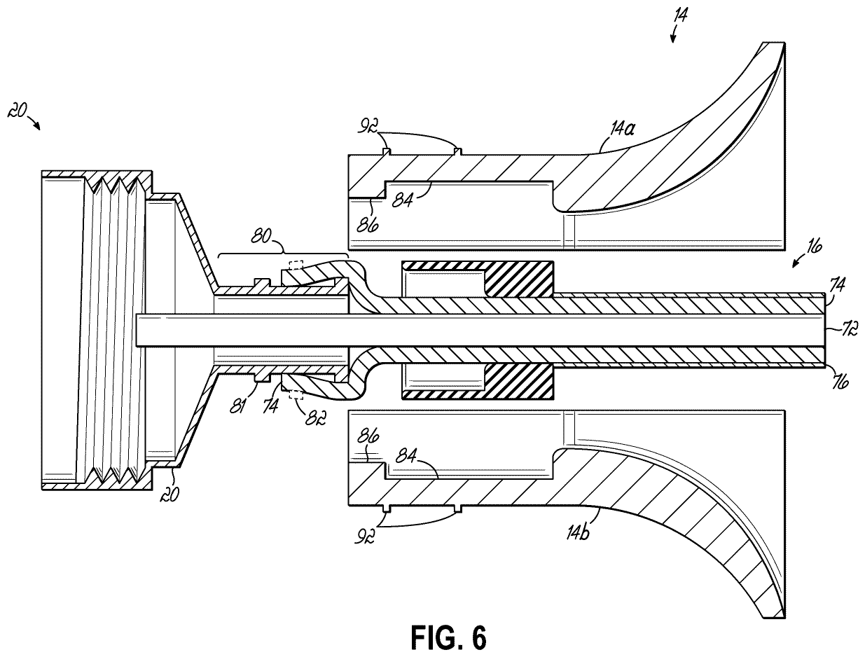

In implementation of the illustrated embodiment, the terminal end 78 of the cable 16 is exposed and inserted through the cable interface element 12. More specifically, the shield element 74 and conductor(s) 72 are exposed by removing any insulation or jacket layers, and the elements are presented to a connector back shell element 20 as show in FIG. 6. The auxiliary strain relief element 14 is in multiple pieces as illustrated, such as in a clam-shell configuration including sections 14a, 14b, for being positioned over the terminal end 78 and cable interface element 12 as discussed herein. Referring to FIG. 6, the conductor(s) 72 and shield 74 engage a nipple portion 80 of a back shell. The conductor(s) pass through the nipple portion 80 and the back shell to then be terminated in an appropriate socket or pin (not shown) making up the actual finished connector assembly. As understood by a person of ordinary skill in the art, the type of connector configuration is not limiting to the disclosed embodiments.

The shield 74 or other appropriate layer is expanded as necessary and slides over the nipple portion 80 as illustrated. The shield 74 may be secured around the nipple portion with a metal or plastic band 82 that may be crimped or cinched tight around the nipple portion 80 in order to secure the shield and form a strain relief anchor for the cable 16 at the connector back shell. Once the shield 74 has been secured, the cable interface element 12 may be positioned over the nipple portion 80 and shield. That is, the larger second inner diameter 54 of element 12 will envelope the nipple portion 80 and the secured shield 74 as shown in FIG. 6. The cable interface element 12 is formed of a suitable flexible material as noted to allow it to be expanded as needed and positioned over the nipple portion and shield. The smaller first inner diameter 52 may be configured and sized for interfacing with the cable as shown in FIG. 6 and securely fitting around the outside of cable 16. The larger second inner diameter 54 is configured and sized for interfacing with the connector and specifically is configured to accommodate the nipple portion of a connector and a shield that is anchored thereon.

Referring to FIG. 7, each of the sections 14a, 14b of the auxiliary strain relief element 14 are configured for fitting around the cable and cable interface element 12. To that end, each of the sections 14a, 14b have a suitably shaped and configured groove portion therein such that when the two sections are brought together to form the auxiliary strain relief element 14, they form a groove 84 around an inside surface of the element 14 to capture the interface element 12 and a portion of the connector assembly and cable as shown in FIG. 7. The groove 84 is dimensioned and configured so that the cable interface element 12 fits into the groove 84 in the completed connector assembly. That is, the groove receives the interface element 12 and cable to center and secure the cable in the body of the strain relief element 14. The two sections 14a, 14b are brought together around the nipple portion 80, the cable interface element 12 and the terminal end 78 of the cable 16.

Referring to FIG. 5, the nipple portion 80 may include one or more ridges 81 that extend radially outwardly from an outer surface 83 of the nipple portion. The ridges 81 are positioned along the length of the nipple portion for capturing the shield 74 therebetween and seating the shield between the ridges. Generally, the spacing of ridges 81 may coincide with the section of cable interface element 12 that has the larger second inner diameter 54. Thus, in the inner diameter 54 of the cable interface element 12, additional room for the shield 74 and any band 82 that secures the shield with the nipple portion 80 is provided inside of element 12. In that way, as illustrated in FIG. 7, the cable interface element 12 fits snugly against the nipple portion 80 and protects the shield 74 and strain relief feature of the cable 16 and back shell 20. The groove 84 may be dimensioned in longitudinal length such that the forward end of auxiliary strain relief element 14 that interfaces with the back shell 20 forms a shoulder portion 86 that abuts the forwardmost ridge 81. Thereby, the auxiliary strain relief element 14 is prevented from being pulled longitudinally from the back shell once installed.

Once the clam-shell sections 14a, 14b are secured around the cable and cable interface element 12, as illustrated and FIG. 7, the sections may be secured together to form a unitary auxiliary strain relief element 14. For example, a band 90 may be clamped or cinched around the element sections to form the auxiliary strain relief element 14. One or more ridges 92 might also be implemented on the auxiliary strain relief element 14 to capture any band 90 and prevent it from moving longitudinally along the auxiliary strain relief element 14. In that way, a unitary auxiliary strain relief element 14 is provided to longitudinally move the point of flexure rearwardly away from the end of the connector back shell and further contain the overall flexure of the end of the cable within a defined radius as illustrated in FIG. 2.

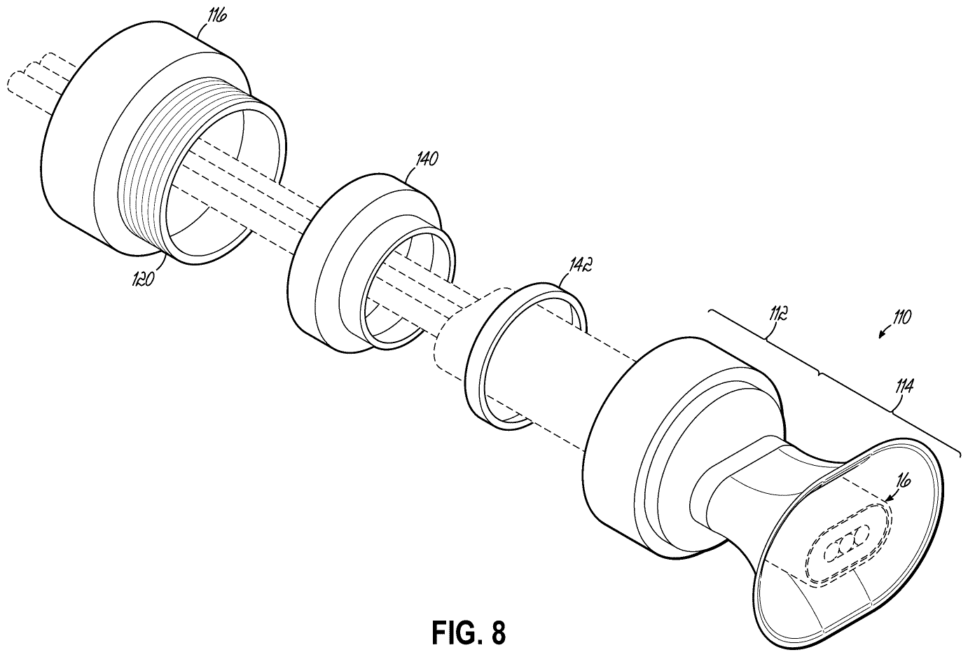

FIGS. 8-13 illustrate an alternative disclosed embodiment wherein the features of the auxiliary strain relief element 14 are integrally incorporated into a connector or connector system that includes a connector back shell. Specifically, referring to FIG. 8, a back shell connector or connector system is show that includes first connector element 116 and second connector element 110 that is configured to interface with and be secured with element 116, such as by threads, to complete the connector. The connector element 110 incorporates features of the disclosed embodiments and includes a body defining a passage therethrough for a cable to pass through the body. In the illustrated embodiment, the body is in the form of a connector back shell element 110 having a back shell portion 112 configured for interfacing with another connector element, and also having an auxiliary strain relief portion 114 extending integrally from the back shell portion to form an auxiliary strain relief element 110. The auxiliary strain relief element 110 may be utilized to terminate and connect a cable similar to cable 16 as shown in FIG. 1, and thus similar cable elements and reference numerals are used herein for illustrating the embodiment of element 110. Element 110 may be formed of a suitable rigid material, such as the materials discussed with respect to element 14, and in one embodiment may be formed of as a metal material like that used for connectors, such as military connectors having bodies and back shells or back shell portions. The back shell portion 112 will generally be compatible with various connector designs, such as military or mil-spec connectors, and therefore will generally have a circular cross section as illustrated in the figures.

The back shell portion 112 of element 110 may have appropriate threads 118 therein, as illustrated in FIGS. 11-13, for coupling with or interfacing with other connector assembly elements, such as screwing onto another connector element 116 having compatible threads 120. The threads 118, 120 may be implemented between the connector sections for securing them together at the terminal end of a cable 16. As will be understood by a person of ordinary skill in the art, other means of coupling the connector element 116 and portion 112 of element 110 together might be utilized depending upon the type of connector which implements the disclosed embodiments.

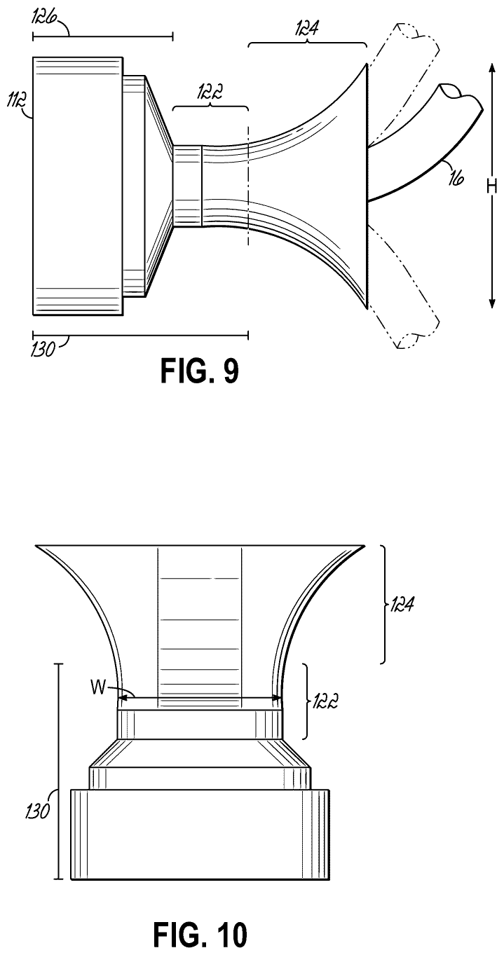

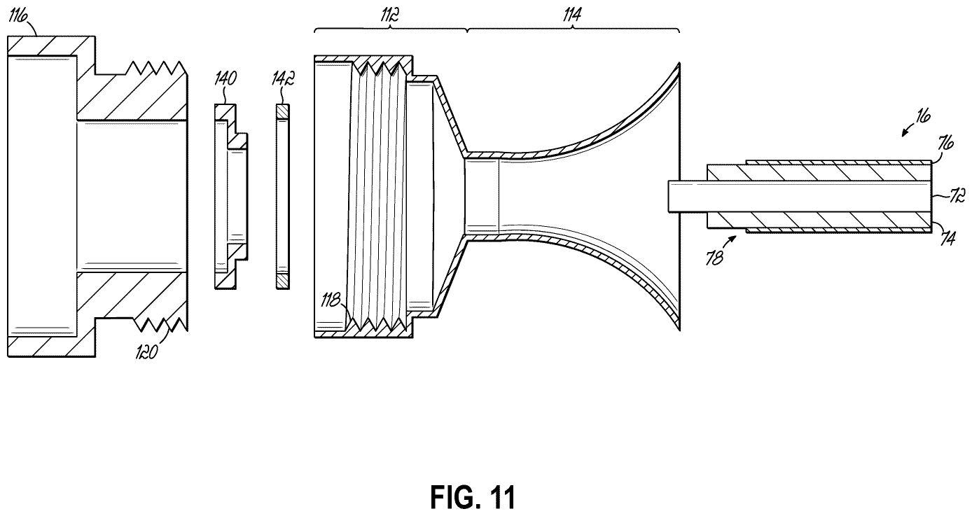

In the illustrated embodiment, as shown in FIGS. 8-13 the auxiliary strain relief portion 114 of element 110 will generally resemble auxiliary strain relief element 14 and will have a flared portion. The illustrated embodiment of FIGS. 8-13 is for a flatter or oblong cable having multiple conductors stacked side by side to give the cable a generally oval cross section with a greater width W than height H. Like embodiment of FIGS. 1-7, the element 110 and particularly the auxiliary strain relief portion 114 have an oval cross-sectional shape as illustrated. However, the element 110 might also be utilized with a cable having a circular cross section and so the auxiliary strain relief portion 114 might have a similar circular cross section, resembling the back shell portion 112. FIG. 9 shows a side view of the auxiliary strain relief element 110 while FIG. 10 shows a top view. The auxiliary strain relief portion 114 of element 110 will have a similar radius as illustrated with respect to the auxiliary strain relief element 14 illustrated in FIGS. 1-7 for limiting the maximum flexure of the cable 16.

Referring to FIG. 9, the auxiliary strain relief portion 114 of element 110 has a couple of sections 122, 124. The section 122 is generally a straight longitudinal section (illustrated having an oval cross sectional shape) whereas the section 124 is a flared section for providing the desired flexure angle and ultimate flexure restraint for the cable 16. The straight longitudinal section 122 has an effective longitudinal length that is cumulative with the longitudinal length 126 of the connector back shell portion 112. This provides an overall effective length 130 from the connector element 116 to the flared section 124 of ⅛ to 3 inches which provides a sufficient distance rearwardly from the terminal end of the cable 16 and connector element 116 for preventing sharp bends and damage to the cable at the connector, as discussed herein. Rather, the flexure is spaced further rearwardly from the connector, and the flexure angle is defined and confined to thus provide auxiliary strain relief and dynamic protection of the end of the terminal end of the cable.

Referring to FIG. 10, a top view of element 110 is illustrated showing the larger width than height of the auxiliary strain relief portion 114 for handling an oval or flatter cable. As such, the width dimension W of the auxiliary strain relief portion 114 is greater than the height dimension H as discussed herein with respect to the embodiment of FIGS. 1-7. Element 110 and specifically the auxiliary strain relief portion 114 thereof provide a maximum vertical flex radius matching the bend radius of a cable similar to the element 14 discussed herein. So the portion 114 is configured similar to element 14 in the embodiment in FIGS. 1-7 with a sloping inner surface and effective radius to prevent a sharp flexure angle or bend when cable 16 is used in dynamic applications.

FIGS. 11-13 illustrate assembly and use of the embodiment of element 110 at the terminal end of a cable 16. The relative sizes and dimensions of the element 110 are not necessarily to scale and are shown for illustrative purposes primarily. A particular cable construction and a particular connector having element 116 and back shell portion 112 of element 110 are illustrated for demonstrating the disclosed embodiments; however, it will be readily understood that the disclosed embodiments would be applicable to other connectors with different connector elements and shapes and back shell shapes and other cable designs beyond those shown, with only slight modifications or dimensional changes to the elements as would be understood by a person of ordinary skill in the art. Referring to FIG. 11, cable 16 is illustrated. The cable 16 may have many configurations with respect to its construction and components, such as the number of conductors, layers of insulation and materials utilized as noted herein and thus the cable is not limiting to the disclosed embodiments. For illustration, a cable 16 has one or more conductors, with each conductor covered in an appropriate insulative layer for electrical isolation in the cable. A shield or outer conductor 74 surrounds the one or more conductors 72. A jacket 76 or other insulation layers might surround the various components 72,74 as discussed herein.

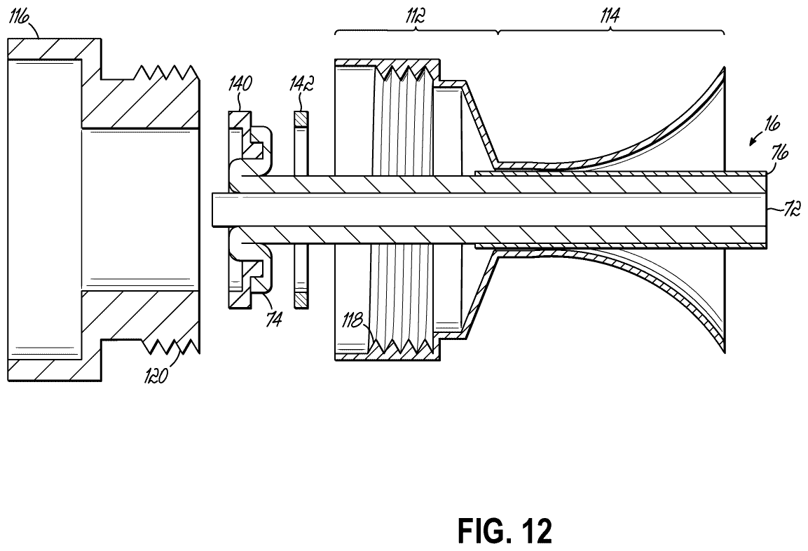

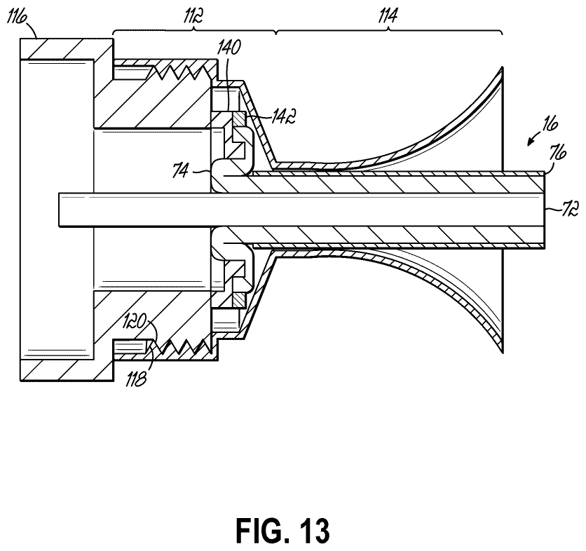

In implementation of the illustrated embodiment, the terminal end 78 of the cable 16 is exposed and inserted through the element 110 and through portions 114 and 112. More specifically, the shield element 74 and conductor(s) are exposed by removing any insulation or jacket, and the elements are presented at the back shell portion 112 and an anchor ring element 140 as show in FIG. 11. Unlike the auxiliary strain relief element 14 in multiple pieces, the auxiliary strain relief portion 114 is integral with the back shell portion 112 and the cable terminal end 78 extends through both portions 112, 114. Referring to FIG. 12, the conductor(s) 72 and shield 74 engage and pass through the anchor ring element 140, with the shield 74 passing over the anchor ring. The conductor(s) 72 pass through the element 110 and anchor ring element to then be terminated in an appropriate socket or pin (not shown) making up part of the actual connector, such as in connector element 116. As understood by a person of ordinary skill in the art, the type of connector configuration of the element 116 and back shell portion 112 of element 110 is not limiting to the disclosed embodiments. A portion of the cable may be anchored by the anchor ring element. Specifically, the shield 74 slides over the anchor ring element 140 as illustrated. The shield 74 may be secured around the anchor ring element 140 with a metal or plastic band 142 that may be crimped or cinched tight around the anchor ring element 140 and the shield 74 in order to secure the shield and form a strain relief for the cable 16. The anchor ring element and shield are then captured between a connector element such as connector element 116 and the embodiment of element 110. The anchor ring element 140 is configured to be received by the back shell portion and specifically to seat and be secured in the connector element 116 and the back shell portion 112 when they are brought together and secured as shown in FIG. 13.

Referring to FIG. 13, the anchor ring element 140 and the shield are captured and held in place between element 116 and portion 112 of element 110. In that way, the cable has one level of desired strain relief provided by the anchored shield. The end of the cable 16 then extends rearwardly along the length 130 made up of the length 126 of the back shell portion 112 and the longitudinal section 122 of element 110. This length 130 spaces the flex point of the cable away from the anchor ring 140 and the terminal end of the cable and present the flex point to the flared section 124 that can control the flexure angle and further provide auxiliary strain relief in accordance with the disclosed embodiments.

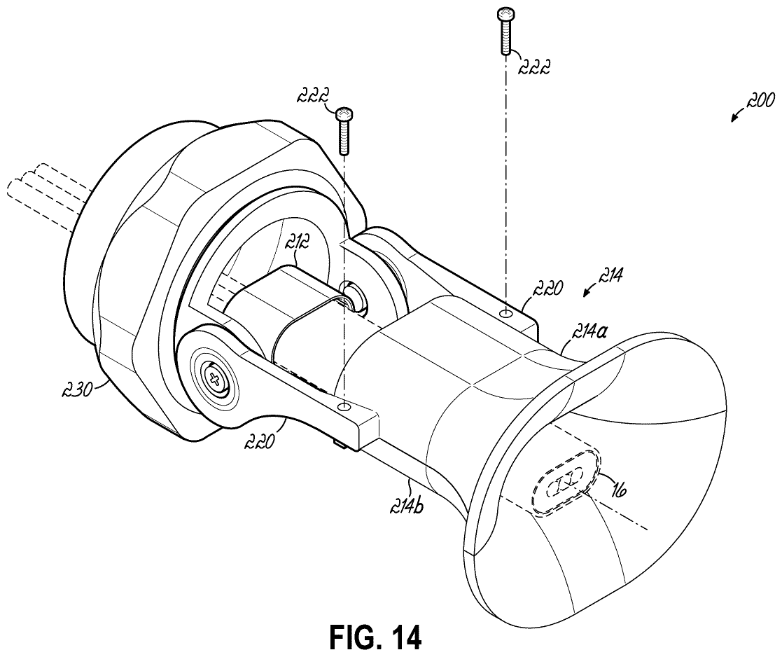

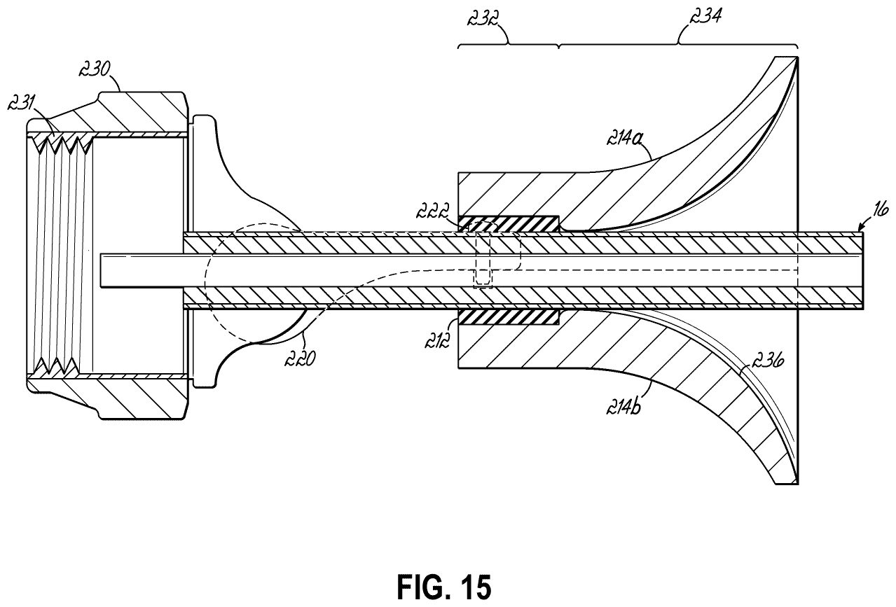

FIGS. 14-15 illustrate an alternative disclosed connector embodiment wherein the features of the auxiliary strain relief element are integrally incorporated into a connector element that is part of a connector. Specifically, referring to FIG. 14, connector element 200 is in the form of a connector back shell element having a back shell that is part of a connector system and is configured for interfacing with another connector element, such as element 116 as shown in FIGS. 8-13. Connector element 116 is not illustrated in FIGS. 14-15 for simplicity. The connector element includes a back shell connector portion 230 that implements legs to space the strain relief element rearwardly from the back shell interface. Specifically, referring to FIG. 14, connector element 200 includes the connector back shell portion 230 that is configured for interfacing with another connector element, such as element 116 as shown in FIGS. 8-13 with suitable threads. The connector element 200 also includes a flared portion 214 that acts as an auxiliary strain relief portion extending rearwardly from the back shell element to form an auxiliary strain relief connector element 200. The auxiliary strain relief connector element 200 may be utilized to terminate and connect a cable similar to cable 16 as shown in FIG. 1, and thus similar cable elements and reference numerals are used herein for illustrating the embodiment of connector element 200. The back shell connector portion 230 may include a body formed of a suitable rigid material, such as a metal or rigid plastic material as noted herein with respect to other embodiments or traditional connectors having bodies and back shells or back shell portions. The back shell portion 230 will generally be compatible with various connector designs, such as military or mil-spec connectors, and therefore will generally have a circular cross section as illustrated in the figures. The back shell portion 230 of connector element 200 may have appropriate threads 231 therein, as illustrated in FIG. 15 for screwing onto another connector element 116 (See FIG. 11) having compatible threads at the terminal end of a cable 16. As will be understood by a person of ordinary skill in the art, other means of coupling a connector element with back shell portion 230 of connector element 200 together might be utilized depending upon the type of connector which implements the disclosed embodiments.

In the illustrated embodiment, as shown in FIGS. 14-15, the connector element 200 also includes an auxiliary strain relief element or portion 214 that will generally resemble auxiliary strain relief element 14 and be configured with similar materials as disclosed herein. Like the embodiment of FIGS. 1-7, the auxiliary strain relief portion 214 could have an oval or circular cross sectional shape. The auxiliary strain relief portion 214 provides a maximum vertical flex radius matching or exceeding the bend radius of a cable similar to the element 14 discussed herein. So the portion 214 is configured similar to element 14 in the embodiment in FIGS. 1-7 with a curved or sloping inner surface that presents an effective radius to limit flexure to prevent a sharp flexure angle or bend when cable 16 is used in dynamic applications. That is, embodiments, the auxiliary strain relief portion 214 contains or restricts the cable to have an effective radius in the vertical plane of the cable that does not exceed and reflects the smallest bend radius for the particular cable. As noted, the bend radius presented by the auxiliary strain relief portion 214 might also exceed the bend radius of the cable. That is, the flared or curved inner surface 236 will ensure that the cable is contained as shown in FIG. 2 so as not to bend at a curvature that is greater than the curvature defined by the bend radius of the cable.

In the embodiment of FIGS. 14-15, the auxiliary strain relief portion 214 is spaced rearwardly of the back shell portion 230 and is coupled to the back shell portion with at least one leg 220. The illustrated embodiment shows a plurality of legs 220, but a single leg may be sufficient for supporting the strain relief portion 214. The leg or legs 220 space the auxiliary strain relief portion 214 and flex point of the cable rearwardly of the interface at the back shell portion 230 as shown in FIG. 15. Referring to FIG. 15, the flared portion or auxiliary strain relief portion 214 of connector element 200 has a couple of sections 232, 234 along its length. The section 232 is generally a straight longitudinal portion whereas the section 234 is a flared section for providing the desired flexure angle and ultimate flexure restraint for the cable 16. Because the legs 220 provide the spacing of the bend or flex point of the cable away from the back shell interface, the straight longitudinal section 232 can have an effective longitudinal length that is less than the longitudinal length of other strain relief embodiments as shown, such as in FIG. 1-7. The cumulative length of section 232 with the length of legs 220 provide the desired spacing as noted with the other disclosed embodiments. For example, the cumulative length of the legs and section 232 may provide an overall effective length from the connector portion 230 to the flared portion 234 of ⅛ to 3 inches as discussed herein. The flared section 234 includes a curved or flared inner surface 236 that defines the flexure angle and confines the flexure to the minimum bend radius of the cable or to a bend radius that exceeds the bend radius of the cable to thus provide auxiliary strain relief and dynamic protection of the end of the terminal end of the cable in accordance with the disclosed embodiments discussed herein.

Referring to FIGS. 14-15, the auxiliary strain relief portion 214 of connector element 200 is configured in multiple pieces or sections 214a, 214b similar to the auxiliary strain relief element 14 of FIGS. 5-7. The sections 214a, 214b may be in a clam-shell configuration for being positioned over the terminal end of the cable and a cable interface element 212 as discussed herein. The connector element 200 includes a cable interface element 212 similar to the cable interface element 12 of embodiment 10. The cable interface element 212 may be made of similar flexible material as element 12 as disclosed herein. The cable interface element 212 is flexible and compressible and is captured by a groove 223 formed in the auxiliary strain relief portion 214 to provide a secure interface of the auxiliary strain relief portion 214 around the cable 16 as shown in FIG. 15.

Referring to FIG. 14, one of the clam-shell sections 214a, 214b of the auxiliary strain relief portion 214 is integral with the legs 220 for securing the auxiliary strain relief portion 214 with the connector back shell portion 230. The other clam-shell section is then removably fixed to its counterpart by appropriate fastening means. For example, in the disclosed embodiment, section 214a may be integrally formed with the legs 220. The cable 16 may be inserted through cable interface element 212 and then secured with connector portion 230, such as similar to securing the cable in the embodiment of FIGS. 8-13. That is, the shield might be secured with an anchor ring element 140 (not shown in FIG. 15). The clam-shell section 214a is positioned on one side of the cable to interface with the cable interface element 212 and then the other clam-shell section 214b is married with section 214a to surround the cable as seen in FIG. 15 and capture the interface element 212. The clam-shell sections 214a, 214b are secured around the cable such as by using fasteners, such as screws 222, that fit through appropriate portions of each of the clam-shell sections as shown in order to form essentially a unitary auxiliary strain relief portion 214 as shown in FIG. 15. Alternatively, other securing structures such as bands may be used as referenced with respect to FIG. 7. The curved inner surface 236 of the clam-shell sections are appropriately curved for creating the desired bend radius restraint as discussed. In that way, an auxiliary strain relief portion 214 is provided to longitudinally move the point of flexure rearwardly away from the end of the connector back shell portion and further contain the overall flexure of the end of the cable within a defined bend radius as illustrated in FIG. 2.

The relative sizes and dimensions of the element of the embodiment in FIGS. 14-15 are not necessarily to scale and are shown for illustrative purposes primarily. A particular cable construction and a particular connector design and back shell portion 230 are illustrated for demonstrating the disclosed embodiments; however, it will be readily understood that the disclosed embodiments would be applicable to other connector shapes and back shell shapes and other cable designs beyond those shown, with only slight modifications or dimensional changes to the elements as would be understood by a person of ordinary skill in the art. The cable 16, as noted, may have many configurations with respect to its size, construction and components, such as the number of conductors, layers of insulation and materials utilized as noted herein and thus the cable is not limiting to the disclosed embodiments.

In the implementation of the illustrated embodiment in FIGS. 14-15, the terminal end of the cable 16 is inserted through the element 212 and in a section 214a, 214b. The shield element is exposed and conductor(s) are terminated appropriately at the back shell portion 230 with the shield secured in appropriate conventional ways, as discussed herein and shown in FIGS. 8-13. The auxiliary strain relief portion 214 is secured around cable interface element 212 that sits in groove 223 and the cable 16 to complete the assembly. As understood by a person of ordinary skill in the art, the type of connector configuration of back shell portion 230 is not limiting to the disclosed embodiments.

Referring to FIG. 15, the cross-sectional view illustrates the auxiliary strain relief portion 214 positioned and secured over the cable 16 and cable interface element 212. The auxiliary strain relief portion 214 is spaced rearwardly from the backshell portion 230 by the length of legs 220 which longitudinally move the point of flexure rearwardly away from the end of the connector back shell portion. The auxiliary strain relief element 214 contains the overall flexure of the end of the cable within a defined radius as described herein and illustrated in FIG. 2.

The embodiments shown and described above are only examples. Even though numerous characteristics and the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that they embodiments described above may be modified within the scope of the claims.

What is claimed is:

1. A device for providing strain relief to a cable having a bend radius and terminated at a connector, the device comprising:
an auxiliary strain relieve element having a body defining a passage therethrough for a cable to pass through the body;
the body formed of a rigid material and including a longitudinal portion configured for interfacing with a connector and with the cable;
the body further having a flared portion contiguous with the longitudinal portion for directing a cable and controlling flexure of the cable;
the flared portion having a curved inner surface that presents an effective bend radius that is equal to or exceeds the bend radius of the cable.

2. The device of claim 1 further comprising a cable interface element configured to fit around the cable, the auxiliary strain relief element configured to capture the cable interface element and cable.

3. The device of claim 2 wherein the cable interface element is formed of a flexible material that is more flexible than the body of the auxiliary strain relieve element.

4. The device of claim 2 wherein the body includes a groove around an inside surface, the groove configured to receive the cable interface element so the auxiliary strain relief element captures the cable interface element and cable.

5. The device of claim 1 wherein the body includes multiple sections in a clam-shell configuration for forming the passage therethrough.

6. The device of claim 2 wherein the cable interface element includes a first inner diameter for interfacing with the cable and a larger second inner diameter configured for interfacing with a connector.

7. A connector for providing strain relief to a cable having a bend radius, the connector comprising:
a first connector element;
a second connector element configured to interface with the first connector element, the second connector element including a connector body defining a passage therethrough for a cable to pass through the body;
the body formed of a rigid material and including a back shell portion configured for interfacing with the first connector element and an auxiliary strain relief portion;
the auxiliary strain relief portion of the body further having a flared portion extending integrally from the back shell portion for directing a cable and controlling flexure of the cable;
the flared portion having a curved inner surface that presents an effective bend radius that is equal to or exceeds the bend radius of the cable.

8. The connector of claim 7 wherein the back shell portion includes threads for coupling with the first connector element.

9. The connector of claim 7 further comprising an anchor ring element, the anchor ring element configured for anchoring a portion of a cable and for being received by the back shell portion for being captured between the back shell portion of the second connector element and first connector element.

10. A connector for providing strain relief to a cable having a bend radius, the connector comprising:
a first connector element;
a second connector element configured to interface with the first connector element, the second connector element including a back shell portion formed of a rigid material;
the second connector element further including an auxiliary strain relief portion formed of a rigid material and having a body defining a passage therethrough for a cable to pass through the body;
at least one leg coupling the auxiliary strain relieve portion with the back shell portion rearwardly of the back shell portion;
the auxiliary strain relief portion body having a flared portion for directing a cable and controlling flexure of the cable;
the flared portion having a curved inner surface that presents an effective bend radius that is equal to or exceeds the bend radius of the cable.

11. The connector of claim 10 further comprising a cable interface element configured to fit around the cable, the auxiliary strain relief portion configured to capture the cable interface element and cable.

12. The connector of claim 11 wherein the cable interface element is formed of a flexible material that is more flexible than the body of the auxiliary strain relieve portion.

13. The connector of claim 11 wherein the body includes a groove around an inside surface, the groove configured to receive the cable interface element so the auxiliary strain relief portion captures the cable interface element and cable.

14. The connector of claim 10 wherein the auxiliary strain relief portion body includes multiple sections in a clam-shell configuration for forming the passage therethrough.

15. The connector of claim 10 further comprising a plurality of legs coupling the auxiliary strain relieve portion with the back shell element rearwardly of the back shell element.
